(19) United States
(12) Patent Application Publication
(10) Pub. No.: US 2002/0122226 A1
(43) Pub. Date: Sep. 5, 2002

(54) Network element and method for compensation of tilting

(76) Inventor: Guenter Spanner, Holzkirchen (DE)

Correspondence Address: BELL, BOYD & LLOYD, LLC, P. O. BOX 1135, CHICAGO, IL, 60690-1135, US

(21) Appl. No.: 10/054,637

(22) Filed: Jan. 22, 2002

(30) Foreign Application Priority Data
Jan. 23, 2001 (DE) 101 02 870.9

(51) Int. Cl. H04J 14/02; H04B 10/00

(52) U.S. Cl. 359/124; 359/161

(57) ABSTRACT

An optical network element, an optical data transmission link and method for tilting and ripple compensation by splitting the data signal into sub-bands and individual amplification of the sub-bands.

### BACKGROUND OF THE INVENTION

The present invention relates to a network element and a method for compensation of tilting in data transmission links of a wavelength division multiplex system for optical data transmission signals having at least one input for an optical N-channel input signal and at least one output for an altered N-channel output signal.

It is known overall to compensate for the tilting and, if appropriate, the ripple of optical data transmission signals by way of their frequency through the use of elements through which the entire frequency spectrum of the signal of a WDM system runs. In this case, it has been found that such compensation is so inadequate that, due to the inadequate dynamic range, network elements for compensation of the tilting and ripple already have to be used even after traversal of six to ten optical amplifiers in a data transmission link.

Therefore, it is an object of the present invention to find network elements having an improved dynamic range.

### SUMMARY OF THE INVENTION

Accordingly, the present invention proposes a network element for compensation of tilting and ripple in data transmission links of a wavelength division multiplex system for optical data transmission signals having at least one input for an optical N-channel input signal and at least one output for an altered N-channel output signal, which network element is improved to the effect that provision is made of at least one demultiplexer for frequency-dependent splitting of the input signal into a multiplicity of paths for individual sub-bands, per path at least one amplifier and at least one multiplexer for combination of the separate bands.

This results in a significantly higher dynamic range, since it is now possible, for example, through an individual setting or presetting of the individual amplifiers, to deal with the respective form of the tilting with a different gradient or a ripple with gradients having different signs and to compensate for the latter. In this case, it is now even possible to compensate for a ripple in the signal by way of the frequency.

The network element according to the present invention also can be configured in such a way that each amplifier has an individual open-loop or closed-loop control. The control signal can be obtained at the end of the transmission link via an optical spectrum analyzer (OSA) and be distributed to the individual network elements via an optical supervisory channel (OSC).

Since the individual amplifiers in the paths generate, to a first approximation, only a uniform raising or lowering of the signal in their individual path, it is furthermore advantageous if at least one path, preferably all the paths, has or have a dispersion-compensating element (DCM: Dispersion Compensating Module). This results in optimal compensation of any ripple, tilting and dispersion of the entire data transmission signal and, hence, a significantly lower transmission error rate.

According to the present invention, the network element additionally may have a common amplifier acting over the entire spectrum of the data transmission signal upstream of the demultiplexer. What is achieved by this is that the technically complicated preamplification can be effected in a common amplifier and the latter is, thus, required only once. The narrowband individual amplifiers then have to provide only a relatively low amplification power, as a result of which they can be embodied with considerably lower technical complexity.

Correspondingly, a common amplifier acting over the entire spectrum of the data transmission signal also may be arranged downstream of the multiplexer. This amplifier can perform the common power amplification of the signal, so that this technically complicated stage is likewise required only once and the individual amplifiers again require only considerably lower technical complexity.

Moreover, a common dispersion-compensating element (DCM) acting over the entire spectrum of the data transmission signal may, in each case, be arranged upstream of the demultiplexer and/or downstream of the multiplexer. This makes it possible to reduce the required action of the path-specific dispersion-compensating element.

Furthermore, it is advantageous if the frequencies are split in the demultiplexer in such a way as to produce K paths with m channels, N=K*m where m is greater than or equal to 1 holding true and N representing the total number of channels. In this case, then, either one channel is, in each case, split onto each path with m=1 or a small frequency band containing a number of channels is transmitted per path with m being greater than or equal to 2.

It also should be pointed out that it is possible to transmit both an identical and a different number of channels in the individual paths.

Furthermore, the present invention also proposes a data transmission link having a transmitter, a receiver and a multiplicity of interposed amplifiers, which data transmission link contains at least one network element according to the present invention.

In accordance with the underlying concept of the present invention, it is additionally proposed to improve the known method for compensation of tilting in data transmission links of a wavelength division multiplex system for optical data transmission signals, to the effect that the frequency band of the optical data transmission signal is split into a multiplicity of small sub-bands, each sub-band being individually amplified or attenuated in such a way that, after combination of the individual sub-bands, an originally existing tilting or ripple is largely compensated.

In addition, a dispersion correction also can take place per sub-band.

Both the individual amplification and the individual tilting influencing can be controlled either in an open-loop or closed-loop manner, thereby enabling optimum dynamic matching to the respective conditions.

In this method, it is furthermore advantageous if the entire data transmission signal with a total of N channels is split between K sub-bands with m channels in each case, N=K*m holding true, where m is greater than or equal to 1.

The present invention additionally proposes equipping a data transmission link with the network elements described in such a way that a measuring point for determining the tilting is arranged downstream of a number of network elements, the measuring point transmitting control information to the controllable network elements connected upstream and controlling the degree of tilting through individual alteration of the amplifier powers in the individual paths and sub-bands. Preferably, at least one measuring point or the sole measuring point should be arranged at the end of the data transmission link.

Additional features and advantages of the present invention are described in, and will be apparent from, the following Detailed Description of the Invention and the Figures.

### BRIEF DESCRIPTION OF THE FIGURES

FIG. 1 shows a simple network element according to the present invention with individual amplifiers per path.

FIG. 2 shows a network element in accordance with FIG. 1 with additional individual EDFAs per path.

FIG. 3 shows a network element in accordance with FIG. 2 with two additional amplifier elements.

FIG. 4 shows a network element in accordance with FIG. 3 with an additional common DCM.

FIG. 5 shows a data transmission link with network elements according to the present invention and cascaded amplifier elements.

FIG. 6 shows a network element in accordance with FIG. 4 with additional open-loop/closed-loop control input for the individual amplifiers.

FIG. 7 shows a data transmission link with network elements from FIG. 6 and cascaded amplifier elements.

FIG. 8 shows a graphical illustration of the tilting and ripple of an untreated data signal.

FIG. 9 shows a graphical illustration of the compensating effect of the network element according to the present invention when applied to the data signal from FIG. 8.

### DETAILED DESCRIPTION OF THE INVENTION

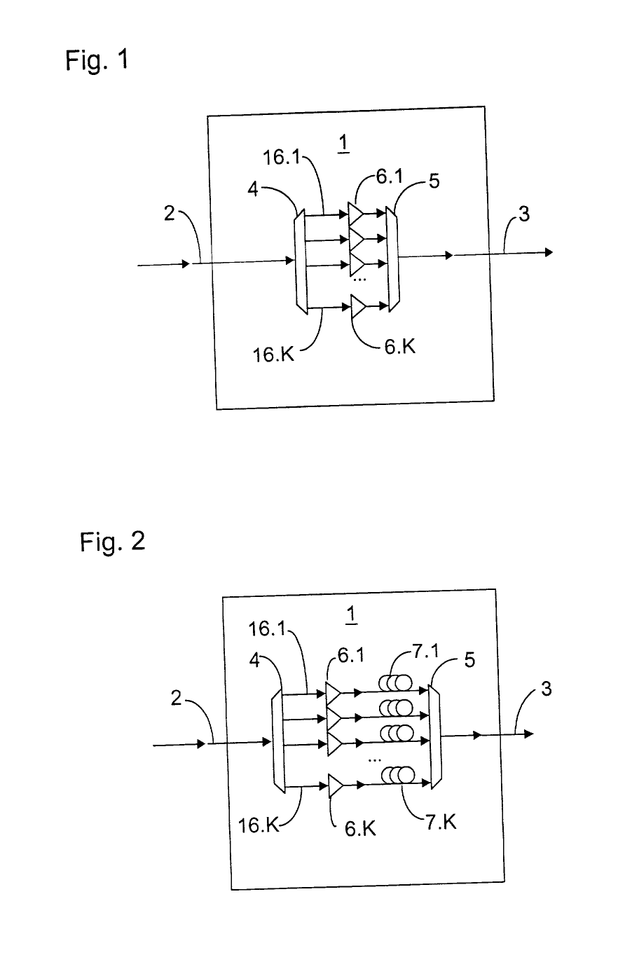

FIG. 1 shows the simplest version of the network element 1 according to the present invention, having one input 2 and one output 3. The data signal is passed via the input 2 to a demultiplexer 4, where the data signal is split into K sub-bands and each sub-band is amplified by an individually assigned amplifier 6.1-6.K in such a way as to produce compensation of an existing tilting of the incoming data signal over the entire bandwidth of the entire signal. Afterward, the sub-bands are forwarded to the multiplexer 5, which combines them and conducts them to the output 3 of the network element 1.

An improved form of the network element 1 according to the present invention is illustrated in FIG. 2. In this case, in addition to the amplifier elements 6.1-6.K in each path 16.1-16.K there is a respective dispersion-compensating element (DCM) 7.1 to 7.K, with which the residual dispersion still remaining, if appropriate, in the individual sub-bands can be compensated for, so that the data signal is improved further.

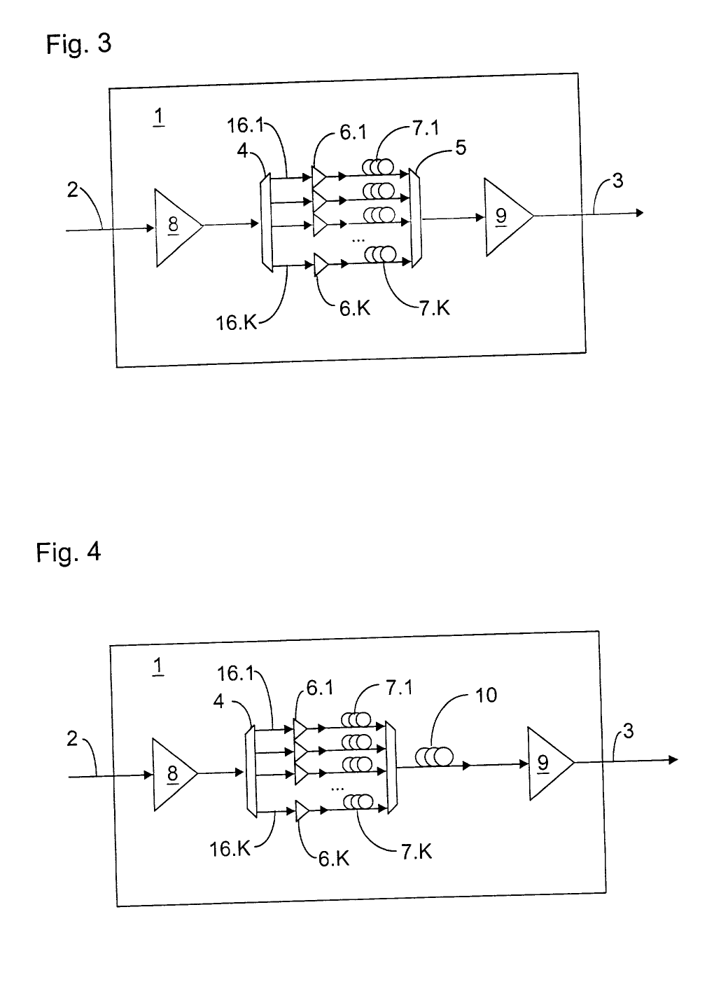

FIG. 3 shows an additional variant of a network element 1 according to the present invention, an amplifier 8 additionally being arranged upstream of the demultiplexer 4 and likewise an amplifier 9 downstream of the multiplexer 5, in order to improve the dynamic range.

Furthermore, FIG. 4 shows a network element 1 according to the present invention from FIG. 3, but with a further dispersion-compensating element 10 between the demultiplexer 4 and the amplifier element 9.

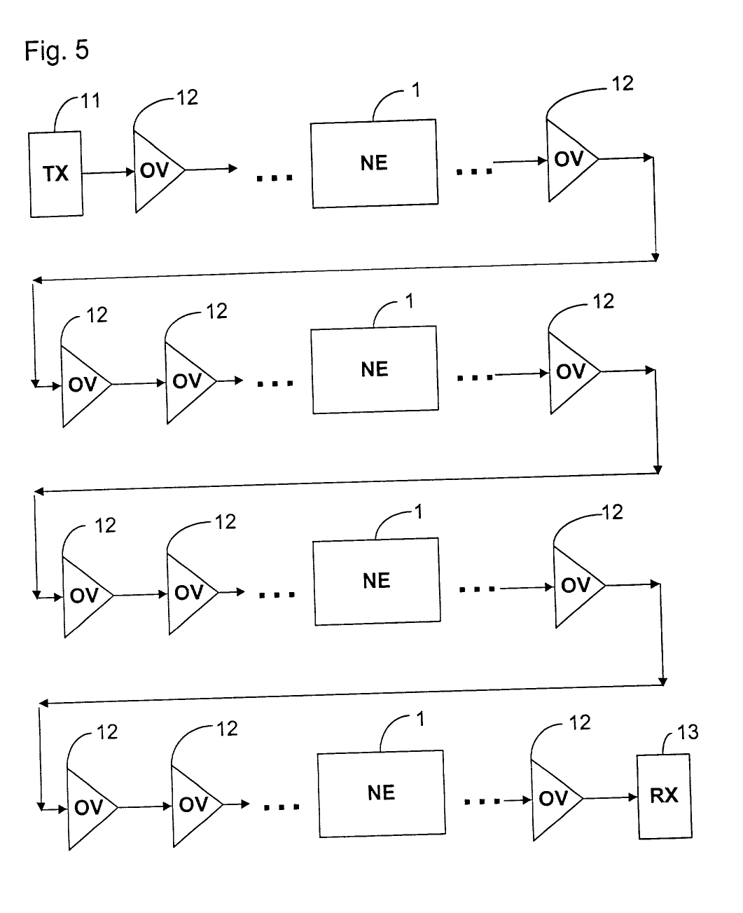

The use of the network element 1 according to the present invention in a data transmission link with cascaded amplifiers is illustrated in FIG. 5, in which, proceeding from a transmitter 11, a multiplicity of serially cascaded amplifier elements 12 with a number of network elements according to the present invention arranged in between lead to a receiver 13.

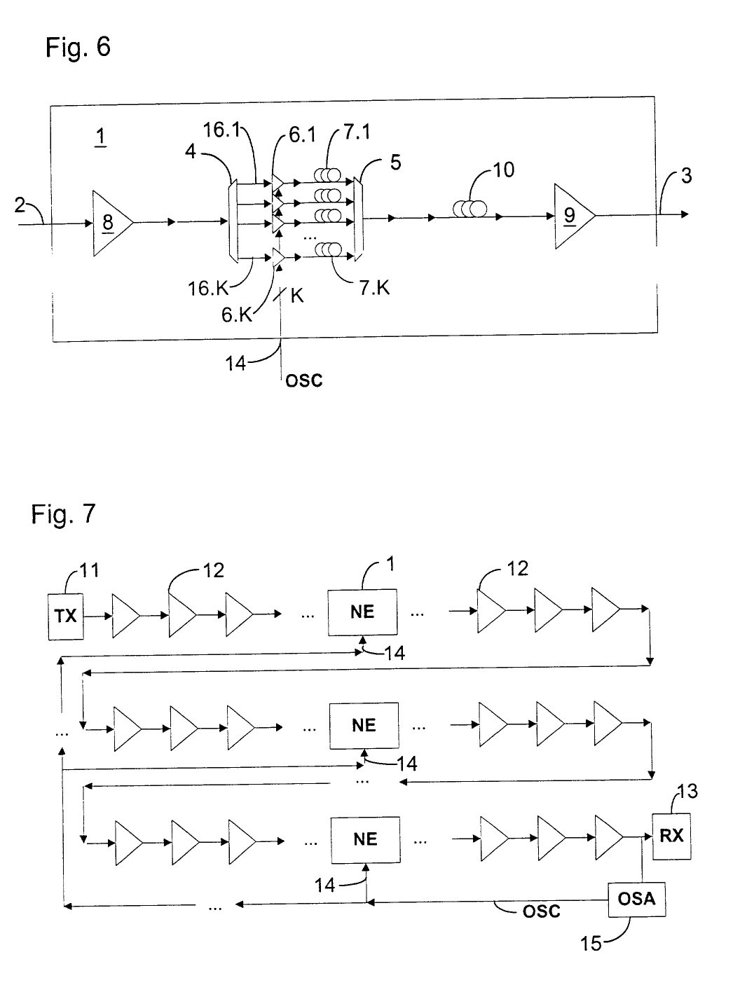

FIG. 6 shows a further variant of a network element 1 according to the present invention. This network element 1 has essentially the structure of the network element illustrated in FIG. 4 and is additionally provided with an input 14 with K channels for individual driving of the K amplifiers 6.1-6.K in the individual paths for individual influencing of the gain in the individual sub-bands.

By way of example, what may be involved here are the inputs of an optical supervisory channel (OSC) as is illustrated in the following FIG. 7.

This FIG. 7 shows a data transmission link, between a transmitter and a receiver 13 with a multiplicity of cascaded amplifiers 12, between which (for controlling the tilting) controllable network elements with control inputs 14 are illustrated. The control inputs 14 are supplied by an optical supervisory channel which extends over the entire data transmission link and whose control signals are obtained via an optical spectrum analyzer (OSA) 15 at the end of the data transmission link.

It should be pointed out that, in the same way, the network elements of the simpler embodiments according to FIGS. 1 to 3 or other combinations of the features illustrated there also can be provided with corresponding control inputs and similar data transmission links can be constructed.

This type of configuration of a data transmission link means that it is now possible, in a simple manner, to compensate for temporal fluctuations in the tilting and/or ripple of the data transmission link.

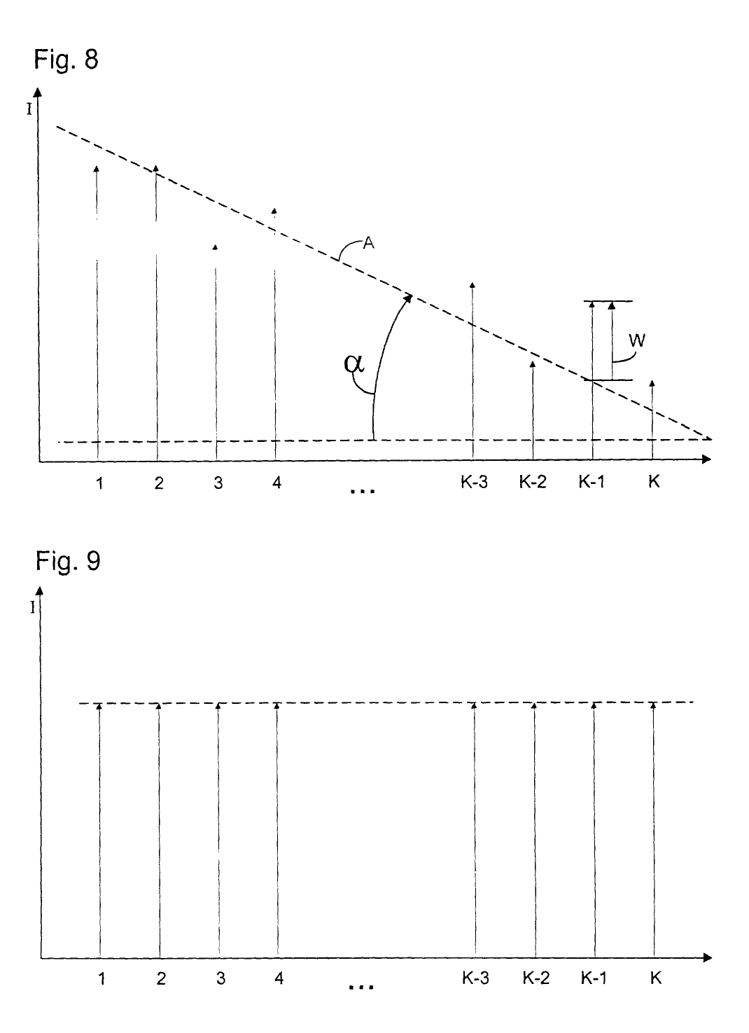

For clarification, FIGS. 8 and 9 again show the compensation of the tilting and ripple of such a data transmission signal.

In FIG. 8, the intensity I of the individual sub-bands, plotted on the abscissa, with rising wavelength or of the channels K is represented by arrows on the ordinate and the average tilting of the intensities is indicated by the angle α. About the average value of the tilting, represented by the oblique straight line A indicated by dashes, the intensities I additionally have a deviation referred to as ripple, whose value is indicated by W on the channel K-1, for example.

Since, in the network element according to the present invention, the gain of the individual channels on the paths 16.1-16.K can be set individually via the amplifiers 6.1-6.K, the amplification power per channel or path can be set in such a way that compensation of the tilting is established, as illustrated in FIG. 9, after the traversal of a network element with the individual amplifiers that are controlled individually.

The use of the network element according to the present invention makes it possible, compared with the prior art, to use a significantly higher number of cascaded, interposed amplifiers 12, until the tilting is compensated for by the network elements.

Overall, then, the present invention describes an optical network element, an optical data transmission link and a method for tilting and ripple compensation by splitting the data signal into sub-bands and individually amplifying the sub-bands, thereby achieving a significantly improved compensation dynamic range.

It is understood that the abovementioned features of the present invention can be used not only in the combination respectively specified but also in other combinations or by themselves, without departing from the spirit and scope of the present invention.

Indeed, although the present invention has been described with reference to specific embodiments, those of skill in the art will recognize that changes may be made thereto without departing from the spirit and scope of the invention as set forth in the hereafter appended claims.

1. A network element for compensation of tilting in data transmission links of a wavelength division multiplex system for optical data transmission signals having at least one input for an optical N-channel input signal and at least one output for an altered N-channel output signal, the network element comprising:
at least one demultiplexer for frequency-dependent splitting of the at least one input signal into a plurality of paths for individual sub-bands; and
at least one amplifier and at least one multiplexer provided for each of the plurality of paths for combining the individual sub-bands.

2. A network element for compensation of tilting in data transmission links of a wavelength division multiplex system as claimed in claim 1, wherein each amplifier has an individual open-loop or closed-loop control.

3. A network element for compensation of tilting in data transmission links of a wavelength division multiplex system as claimed in claim 1, further comprising a dispersion-compensating element in at least one of the plurality of paths.

4. A network element for compensation of tilting in data transmission links of a wavelength division multiplex system as claimed in claim 3, wherein the at least one amplifier is EDFA and is individually controlled in an open-loop or closed-loop manner.

5. A network element for compensation of tilting in data transmission links of a wavelength division multiplex system as claimed in claim 1, further comprising a common amplifier, acting over an entire spectrum of the data transmission signal, arranged upstream of the demultiplexer.

6. A network element for compensation of tilting in data transmission links of a wavelength division multiplex system as claimed in claim 1, further comprising a common amplifier, acting over an entire spectrum of the data transmission signal, arranged downstream of the multiplexer.

7. A network element for compensation of tilting in data transmission links of a wavelength division multiplex system as claimed in claim 1, further comprising a common dispersion-compensating element, acting over an entire spectrum of the data transmission signal, arranged downstream of the multiplexer.

8. A network element for compensation of tilting in data transmission links of a wavelength division multiplex system as claimed in claim 1, wherein K paths with m channels are provided, N=K*m holding true, where m is greater than or equal to 1.

9. A data transmission link, comprising:
a transmitter;
a receiver;
a plurality of amplifier elements interposed between the transmitter and receiver; and
at least one network element interposed between the transmitter and the receiver, the network element for compensation of tilting in the data transmission link of a wavelength division multiplex system for optical data transmission signals having at least one input for an optical N-channel input signal and at least one output for an alterned N-channel output signal, the network element including at least one demultiplexer for frequency-dependent splitting of the at least one input signal into a plurality of paths for individual sub-bands, at further including at least one amplifier and at least one multiplexer for each of the plurality of paths for combination of the individual sub-bands.

10. A data transmission link as claimed in the claim 9, further comprising a measuring device for determining the tilting, the measuring device being arranged downstream of the at least one network element, and by which device control information can be transmitted to the at least one network element for controlling a degree of tilting.

11. A method for compensation of tilting in data transmission links of a wavelength division multiplex system for an optical data transmission signal, the method comprising the steps of:
splitting a frequency band of the optical data transmission signal into a plurality of individual sub-bands; and
subjecting each sub-band, individually, to one of amplification and attenuation such that, after combination of the plurality of individual sub-bands, an originally existing tilting or ripple is largely compensated.

12. A method for compensation of tilting in data transmission links of a wavelength division multiplex system as claimed in claim 11, the method further comprising the step of performing open-loop or closed-loop control of the amplification.

13. A method for compensation of tilting in data transmission links of a wavelength division multiplex system as claimed in claim 11, the method further comprising the step of performing tilting influencing, with an EDFA, for each individual sub-band.

14. A method for compensation of tilting in data transmission links of a wavelength division multiplex system as claimed in claim 13, the method further comprising the step of performing open-loop or closed-loop control of the tilting influencing.

15. A method for compensation of tilting in data transmission links of a wavelength division multiplex system as claimed in claim 11, wherein the entire data transmission signal with a total of N channels is split between K sub-bands with m channels in each case, N=K*m holding true, where m is greater than or equal to 1.
